(19) United States
(12) Patent Application Publication
(10) Pub. No.: US 2015/0192820 A1
(43) Pub. Date: Jul. 9, 2015

(54) LCD SCREEN CAPABLE OF PREVENTING THE PHENOMENON OF BLACKENING LCD PANEL

(71) Applicant: LITEMAX ELECTRONICS INC., NEW TAIPEI CITY (TW)

(72) Inventors: TIEN-TENG YANG, NEW TAIPEI CITY (TW); KUN-YANG LU, NEW TAIPEI CITY (TW)

(73) Assignee: LITEMAX ELECTRONICS INC., NEW TAIPEI CITY (TW)

(21) Appl. No.: 14/147,678

(22) Filed: Jan. 6, 2014

(51) Int. Cl. G02F 1/1333

(52) U.S. Cl. CPC G02F 1/133308

(57) ABSTRACT

An LCD screen capable of preventing the phenomenon of blackening an LCD panel includes a frame, an LCD panel installed in the frame, a first translucent insulating panel installed in the frame and on a front side of the LCD panel and separated from the LCD panel by a first distance, an intake fan installed at the bottom of the frame, an exhaust fan installed at the top of the frame and corresponding to the intake fan, a second translucent insulating panel installed on a front side of the first translucent insulating panel and separated from the first translucent insulating panel by a second distance, and two gas flow holes formed at the top and bottom of the frame respectively. The internal temperature of the LCD screen is maintained below the critical value of blackening to prevent the phenomenon of blackening the LCD panel installed inside the LCD screen.

### FIELD OF TECHNOLOGY

The present invention relates to an LCD screen, in particular to the LCD screen capable of preventing the phenomenon of blackening an LCD panel.

### BACKGROUND

When a conventional LCD screen is installed or placed in a poor environment such as an outdoor environment with the exposure of sunlight, the temperature of the LCD screen is increased, so that the temperature of an LCD panel installed inside the LCD screen is increased as well. If the temperature of the LCD panel exceeds the critical value of blackening such as over 65 C.°, the LCD panel will be blackened, and this phenomenon is called a blackening phenomenon. The critical value of blackening varies with different types of LCD panels, so that this value is not limited to the aforementioned 65 C.° only. When the blackening phenomenon of LCD panel occurs, the LCD panel may be damaged easily, so that users cannot use the LCD screen anymore.

In addition, when the LCD screen is installed or placed in a poor environment such as a hot environment with a high ambient temperature, the temperature of the interior of the LCD screen will rise, and the aforementioned blackening phenomenon of the LCD panel will occur easily.

The “poor environment” as described above refers to an environment that causes an increase of temperature of the interior of the LCD screen.

It is an important subject of the present invention to develop an LCD screen capable of preventing the phenomenon of blackening an LCD panel in order to effectively lower the internal temperature of the LCD screen and prevent the occurrence of the blackening phenomenon to the LCD panel installed inside the LCD screen.

### SUMMARY

Therefore, it is a primary objective of the present invention to overcome the problems of the prior art by providing an LCD screen capable of preventing the phenomenon of blackening an LCD panel installed inside the LCD screen even if the LCD screen is installed or placed in the poor environment.

To achieve the aforementioned and other objectives, the present invention provides an LCD screen capable of preventing the phenomenon of blackening an LCD panel, comprising: an LCD panel, installed in the interior of the frame; a first translucent insulating panel, installed in the interior of the frame and on a front side of the LCD panel, and separated from the LCD panel by a first distance; an intake fan, installed in the interior of the frame; an exhaust fan, installed in the interior of the frame and corresponding to the intake fan; a second translucent insulating panel, installed in the interior of the frame and on a front side of the first translucent insulating panel, and separated from the first translucent insulating panel by a second distance; and two gas flow holes, disposed in the interior of the frame and between the first translucent insulating panel and the second translucent insulating panel, and the gas flow holes being corresponsive to each other, wherein the first translucent insulating panel, the second translucent insulating panel and the gas flow holes form a natural convection space, and the LCD panel, the first translucent insulating panel, the intake fan and the exhaust fan form a compulsory convection space.

In the LCD screen, the first distance and the second distance can be adjusted according to the ambient temperature. For example, if the LCD screen is installed or placed in an outdoor environment and exposed to sunlight continuously, the preferred value for the first distance and the second distance is 10 mm.

The LCD screen further comprises a barrier film attached onto the first translucent insulating panel or the second translucent insulating panel for insulating heat energy. In addition, the barrier film can block at least one of an ultraviolet light and an infrared light.

In the LCD screen, the exhaust fan is installed at the top of the frame when the intake fan is installed at the bottom of the frame, and the exhaust fan is installed at the bottom of the frame when the intake fan is installed at the top of the frame.

In the LCD screen, the gas flow holes are disposed at the bottom and the top of the frame respectively.

The LCD screen further comprises two dustproof units disposed at a vent of the intake fan and a vent of the exhaust fan respectively.

In the LCD screen, the first translucent insulating panel and the second translucent insulating panel are made of glass or plastic.

In summation of the description above, the LCD screen capable of preventing the phenomenon of blackening an LCD panel in accordance with the present invention can maintain the internal temperature of the LCD screen below the critical value of blackening in a poor environment by the installation of the aforementioned components, so as to prevent the occurrence of blackening phenomenon of the LCD panel installed inside the LCD screen.

### BRIEF DESCRIPTION OF THE DRAWINGS

FIG. 1 is a schematic view of an LCD screen capable of preventing the phenomenon of blackening an LCD panel in accordance with a first preferred embodiment of the present invention; and

FIG. 2 is a schematic view of an LCD screen capable of preventing the phenomenon of blackening an LCD panel in accordance with a second preferred embodiment of the present invention.

### DETAILED DESCRIPTION OF THE PREFERRED EMBODIMENTS

The objects, characteristics and effects of the present invention will become apparent with the detailed description of the preferred embodiments and the illustration of related drawings as follows.

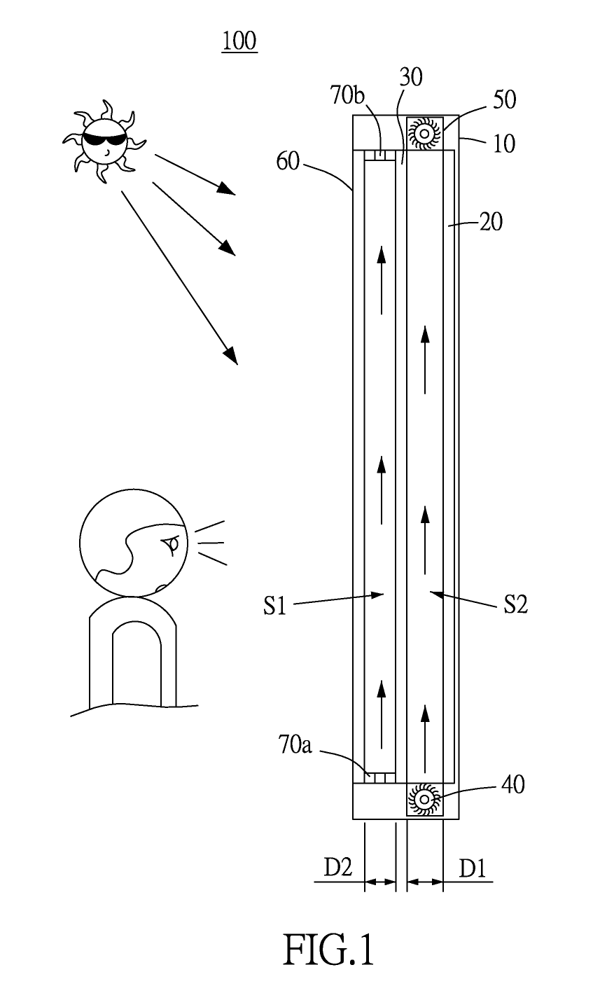

With reference to FIG. 1 for a schematic view of an LCD screen 100 capable of preventing the phenomenon of blackening an LCD panel 20 in accordance with the first preferred embodiment of the present invention, the LCD screen 100 comprises a frame 10, an LCD panel 20, a first translucent insulating panel 30, an intake fan 40, an exhaust fan 50, a second translucent insulating panel 60 and two gas flow holes 70a, 70b.

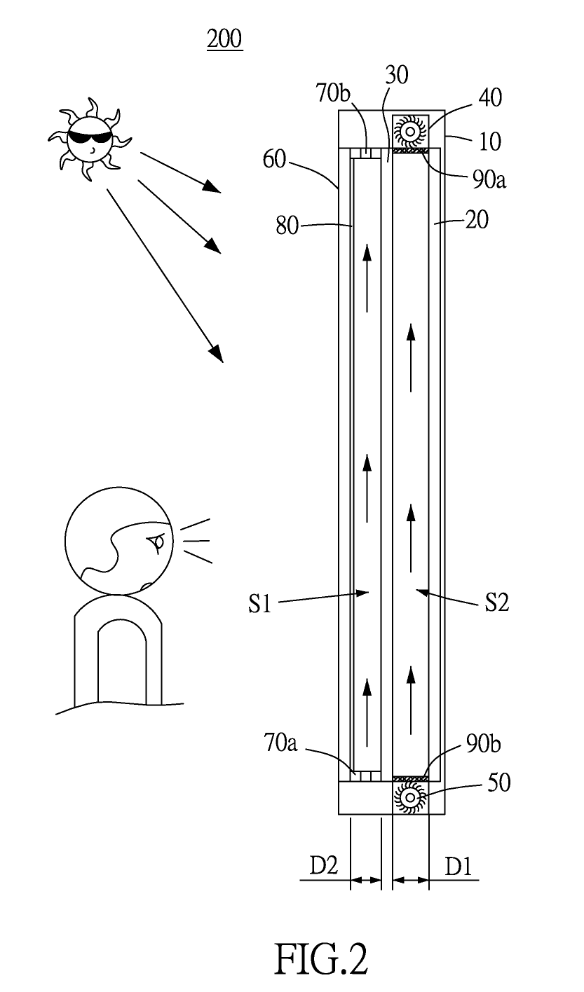

The LCD panel 20 is installed in the interior of the frame 10. The first translucent insulating panel 30 is installed in the interior of the frame 10 and on a front side of the LCD panel 20, and the first translucent insulating panel 30 and the LCD panel 20 are separated with a first distance D1 apart from each other, wherein the first translucent insulating panel 30 is made of a translucent material such as glass or plastic. The intake fan 40 is installed in the interior of the frame 10 and between the LCD panel 20 and the first translucent insulating panel 30. More specifically, the intake fan 40 is installed at the bottom of the frame 10 (as shown in FIG. 1), but the invention is not limited to such arrangement only, since the intake fan 40 can be installed at the top of the frame 10 (as shown in FIG. 2), or on a left side (not shown) or a right side (not shown) of the frame 10 as well. The exhaust fan 50 is installed in the interior of the frame 10 and between the LCD panel 20 and the first translucent insulating panel 30. When the intake fan 40 is installed at the bottom of the frame 10, the exhaust fan 50 is installed at the top of the frame 10. In other words, the position of the exhaust fan 50 is corresponsive to the position of the intake fan 40. The second translucent insulating panel 60 is installed in the interior of the frame 10 and on a front side of the first translucent insulating panel 30, and the second translucent insulating panel 60 and the first translucent insulating panel 30 are separated with a second distance D2 apart from each other, wherein the second translucent insulating panel 60 is made of a translucent material such as glass or plastic. The gas flow holes 70a, 70b are disposed inside the frame 10 and between the first translucent insulating panel 30 and the second translucent insulating panel 60. More specifically, the gas flow holes 70a, 70b are disposed at the top and bottom of the frame 10 respectively. However, the invention is not limited to such arrangement only, and the gas flow holes 70a, 70b can be arranged on the left side or the right side of the frame 10.

In addition, the first distance D1 is preferably over 6 mm, and more preferably over 10 mm. The second distance D2 is preferably over 6 mm, and more preferably over 10 mm. The first translucent insulating panel 30, the second translucent insulating panel 60 and the gas flow holes 70a, 70b define a natural convection space S1, and the LCD panel 20, the first translucent insulating panel 30, the intake fan 40 and the exhaust fan 50 define a compulsory convection space S2.

In FIG. 1, the way how the LCD screen 100 prevents the occurrence of the blackening phenomenon of the LCD panel 20 in an outdoor environment under the continuous exposure of sunlight is described below.

When a sun shines on the LCD screen 100, the second translucent insulating panel 60 blocks some of the solar heat, and a low-temperature air outside the LCD screen 100 is introduced continuously into the natural convection space S1 through the gas flow holes 70a, 70b, while a high-temperature air in the natural convection space S1 is discharged to the outside of the LCD screen 100 to produce a cooling effect in the LCD screen 100. The first translucent insulating panel 30 also blocks some of the solar heat, and finally the low-temperature air outside the LCD screen 100 is drawn into the compulsory convection space S2 by the intake fan 40 and the exhaust fan 50 while the high-temperature air in the compulsory convection space S2 is drawn out of the LCD screen 100 to produce a cooling effect in the LCD screen 100.

Although it is not shown in the figure, the greater the first distance D1 and the second distance D2, the better the cooling effect produced by the natural convection space S1 and the compulsory convection space S2.

The foregoing example shows the environment with the exposure of sunlight only. If the LCD screen 100 is installed or placed in a poor environment such as a hot environment, the aforementioned effect can be achieved as well.

In summation of the description above, both of the first translucent insulating panel and the second translucent insulating panel of the LCD screen capable of preventing the phenomenon of blackening an LCD panel in accordance with the first preferred embodiment of the present invention can block solar heat, and the natural convection space and the compulsory convection space can lower the temperature of the LCD screen to maintain the internal temperature of the LCD screen below the critical value of blackening to prevent the occurrence of the phenomenon of blackening the LCD panel.

With reference to FIG. 2 for a schematic view of an LCD screen capable of preventing the phenomenon of blackening an LCD panel in accordance with a second preferred embodiment of the present invention, the components and installation method of the LCD screen 200 are substantially the same as those of the LCD screen 100 of the first preferred embodiment, but the LCD screen 200 further comprises a barrier film 80 and two dustproof units 90a, 90b, wherein the barrier film 80 is attached onto a rear side of the second translucent insulating panel 60. However, the invention is not limited to such arrangement only, and the barrier film 80 also can be attached onto a front side of the second translucent insulating panel 60 or a front side or a rear side of the first translucent insulating panel 30 as well. The barrier film 80 is provided for blocking heat energy. In addition, the barrier film 80 also can block at least one of an ultraviolet light and an infrared light. The dustproof units 90a, 90b are installed at a vent of the intake fan 40 and a vent of the exhaust fan 50 respectively. The intake fan 40 is installed at the top of the frame 10, and the exhaust fan 50 is installed at the bottom of the frame 10.

Regardless of the installation of the intake fan 40 at the top or the bottom of the frame 10, the operation of the intake fan 40 and the exhaust fan 50 will not be affected. Although it is not shown in the figure, if it is not appropriate to install the intake fan 40 and the exhaust fan 50 at the top and bottom of the LCD screen 200 respectively, then the intake fan 40 and the exhaust fan 50 can be installed on the left side and right side of the frame 10 respectively as needed. This design can also produce the compulsory convection space S2.

The LCD screen capable of preventing the phenomenon of blackening an LCD panel in accordance with the second preferred embodiment of the present invention not only has the advantages and effects of the LCD screen capable of preventing the phenomenon of blackening an LCD panel in accordance with the first preferred embodiment of the present invention only, but also includes the barrier film for enhancing the effect of blocking the heat energy. In addition, the dustproof units can prevent dust in the air from entering into the compulsory convection space through the intake fan or attaching onto the LCD panel.

The heat energy is not limited to solar heat, but it also includes the heat energy generated by the indoor lighting or high-temperature environment.

If the poor environment is a desert environment, the ambient temperature is very high, and more translucent insulating panels, intake fans and exhaust fans can be installed to prevent the occurrence of the blackening phenomenon of the LCD panel effectively.

While the invention has been described by means of specific embodiments, numerous modifications and variations could be made thereto by those skilled in the art without departing from the scope and spirit of the invention set forth in the claims.

What is claimed is:

1. An LCD screen capable of preventing the phenomenon of blackening an LCD panel, comprising:
a frame;
an LCD panel, installed in the interior of the frame;
a first translucent insulating panel, installed in the interior of the frame and on a front side of the LCD panel, and separated from the LCD panel by a first distance;
an intake fan, installed in the interior of the frame;
an exhaust fan, installed in the interior of the frame and corresponding to the intake fan;
a second translucent insulating panel, installed in the interior of the frame and on a front side of the first translucent insulating panel, and separated from the first translucent insulating panel by a second distance; and
two gas flow holes, disposed in the interior of the frame and between the first translucent insulating panel and the second translucent insulating panel, and the gas flow holes being corresponsive to each other, wherein the first translucent insulating panel, the second translucent insulating panel and the gas flow holes form a natural convection space, and the LCD panel, the first translucent insulating panel, the intake fan and the exhaust fan form a compulsory convection space.

2. The LCD screen of claim 1, wherein both of the first distance and the second distance are over 6 millimeters.

3. The LCD screen of claim 2, wherein both of the first distance and the second distance are over 10 millimeters.

4. The LCD screen of claim 1, further comprising a barrier film attached onto the first translucent insulating panel or the second translucent insulating panel.

5. The LCD screen of claim 2, further comprising a barrier film attached onto the first translucent insulating panel or the second translucent insulating panel.

6. The LCD screen of claim 3, further comprising a barrier film attached onto the first translucent insulating panel or the second translucent insulating panel.

7. The LCD screen of claim 4, wherein the barrier film is provided for blocking at least one of an ultraviolet light and an infrared light.

8. The LCD screen of claim 5, wherein the barrier film is provided for blocking at least one of an ultraviolet light and an infrared light.

9. The LCD screen of claim 6, wherein the barrier film is provided for blocking at least one of an ultraviolet light and an infrared light.

10. The LCD screen of claim 1, wherein the exhaust fan is installed at the top of the frame when the intake fan is installed at the bottom of the frame, and the exhaust fan is installed at the bottom of the frame when the intake fan is installed at the top of the frame.

11. The LCD screen of claim 2, wherein the exhaust fan is installed at the top of the frame when the intake fan is installed at the bottom of the frame, and the exhaust fan is installed at the bottom of the frame when the intake fan is installed at the top of the frame.

12. The LCD screen of claim 3, wherein the exhaust fan is installed at the top of the frame when the intake fan is installed at the bottom of the frame, and the exhaust fan is installed at the bottom of the frame when the intake fan is installed at the top of the frame.

13. The LCD screen of claim 1, wherein the gas flow holes are disposed at the bottom and the top of the frame respectively.

14. The LCD screen of claim 2, wherein the gas flow holes are disposed at the bottom and the top of the frame respectively.

15. The LCD screen of claim 3, wherein the gas flow holes are disposed at the bottom and the top of the frame respectively.

16. The LCD screen of claim 1, further comprising two dustproof units disposed at a vent of the intake fan and a vent of the exhaust fan respectively.

17. The LCD screen of claim 2, further comprising two dustproof units disposed at a vent of the intake fan and a vent of the exhaust fan respectively.

18. The LCD screen of claim 3, further comprising two dustproof units disposed at a vent of the intake fan and a vent of the exhaust fan respectively.
